(19) United States
(12) Patent Application Publication
(10) Pub. No.: US 2008/0002267 A1
(43) Pub. Date: Jan. 3, 2008

(54) Method and apparatus for slew rate control in the write current shape of a hard disk drive

(76) Inventors: Eun Kyu Jang, San Jose, CA (US); Dongman Kim, Campbell, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/478,855

(22) Filed: Jun. 29, 2006

(51) Int. Cl. G11B 5/09

(52) U.S. Cl. 360/46

(57) ABSTRACT

Operating a write head by slew rate determining a slew rate control based upon a slew rate and the track being written and controlling the write current waveform based upon the slew rate control for the write head to write data to the track on disk surface. An embedded circuit supporting these operations. Hard disk drive including the embedded circuit electrically coupled to preamplifier driving the write head based upon the write current waveform. Methods of manufacturing the embedded circuit and the hard disk drive, and the products of these processes.

### TECHNICAL FIELD

This invention relates to writing data in hard disk drives, in particular, to apparatus and methods for controlling the shape of the write current stimulating a write head to alter the disk surface forming a track, in particular, by controlling the shape specifically for the track being written.

### BACKGROUND OF THE INVENTION

Contemporary hard disk drives include a head stack assembly pivoting through an actuator pivot to position one or more read-write heads, embedded in sliders, each over a disk surface. The data stored on the disk surface is typically arranged in concentric tracks. To access the data of a track, a servo controller first positions the read-write head by electrically stimulating the voice coil motor, which couples through the voice coil and an actuator arm to move a head gimbal assembly in lateral positioning the slider close to the track. Once the read-write head is close to the track, the servo controller typically enters an operational mode known as track following. It is during track following mode that the read-write head is used to access the data stored of the track. Micro-actuators provide a second actuation stage for lateral positioning the read-write head during track following mode. They often use a thermal-mechanical effect and/or an electrostatic effect and/or a piezoelectric effect to rapidly make fine position changes. They have doubled the bandwidth of servo controllers and are believed essential for high capacity hard disk drives from hereon. Recently, vertical micro-actuators have begun to be used to create what is sometimes referred to as flying height on demand.

What is perpetually needed are mechanisms and methods supporting increased reliability in accessing the tracks on the rotating disk surface of a hard disk drive. Data must be written to the track before it can be read from the track. This invention will focus on the writing of data, in particular to the shape of the write current stimulating the write head to alter the magnetic media of the track on the disk surface.

Typically, the write data waveform is made up of several parameters such as steady state current, overshoot amplitude, overshoot duration, and rise/fall time. Usually, three parameters (Iw, OSA, and OSD) among them are controlled by register values through the serial port interface to optimize both channel and preamplifier. The three parameters are optimized for each head, zone radius, and environment temperature to achieve the best quality of writing. But the rise/fall time tends to be fixed and is not controlled for a given preamplifier.

When the write head reaches target location of the magnetic media to be written, the write current is supplied to the write head. The write current Iw is generally a series of square pulses. To enable faster writing, the frequency of the current pulses also increases. However, as the frequency of the pulses increase, the edge of the pulse becomes distorted because electronics are not able to generate a perfect square wave pulse, and also because the impedance of the write head will deform the pulse shape. To partially alleviate the pulse deformation problem and enable higher frequency writing, write current waveform with overshoot is typically added to the square wave. The overshoot current allows the write pulses to have a faster rise time.

Typically, when the recording bubble expansion speed matches the disk velocity, a transition is formed on the disk. The non-linear transition shift and overwrite are very influenced by the writing frequency and the degradation of write performance with frequency changes which today cannot be completely avoided.

There are other problems. The process of reversing the direction of current flowing through the write head requires a finite rise time. In some hard disk drives with high data rates, the recording rate is so high that the write bubble is unable to fully expand to its steady state size (the V_bubble less than V_disk case). This premature collapse of the write bubble displaces the location of the magnetic transition from the ideal transition edge location by a non-linear amount.

So far, these problems have been overcome by changing the overshoot current amplitude as well as the timing and/or phase characteristics depending on the write data frequency irregularity and using a reference Look-Up Table stored in a memory such as RAM (Random Access Memory) or ROM (Read Only Memory). If V_bubble is less than V_disk, the bubble velocity is slower than the media velocity, and the transition gets written as soon as H_head (the magnetic field of the write head)>Hk (anisotropy field of the disk surface). This is also a problem degrading write performance.

Alternatively, the write current wave form may be modulated dynamically in the write current circuitry to compensate for magnetic transition timing variations. Nevertheless, there exist discrepancies of dynamic electrical test data with respect to radius, making it important to further optimize write current waveform. Further control of the write current waveform to optimize for these conditions.

### SUMMARY OF THE INVENTION

The invention includes a method of operating a write head in a slider to write data in a track on a rotating disk surface in a hard disk drive by slew rate determining a slew rate control using a slew rate based upon the track and controlling the write current waveform generated by a channel interface based upon the slew rate control, where the slew rate includes at least a rising edge slope. As the track changes, its radius changes and the distance traveled by the slider over the rotating disk surface changes. Being able to control the slew rate differently for different tracks means that the hard disk drive can compensate for these changes in velocity. The slew rate may further include a falling edge slope. The write current is a product of this process.

Slew rate determining the slew rate control may further be based upon any combination of the following: a rotating disk surface containing the track and/or a temperature estimate and/or a humidity estimate.

The invention includes an embedded circuit for use in the invention's hard disk drive and supporting the invention's method of operation. It preferably includes a means for slew rate determining the slew rate control using the slew rate based upon the track to be written and a means for controlling the write current waveform generated by the channel interface based upon the slew rate control.

The means for slew rate determining the slew rate control may be at least partly implemented by at least one of the following: a servo computer, an embedded computer, a finite state machine, a neural network and an inferential engine, where the servo computer is directed by a servo program system and the embedded computer is directed by an embedded program system. At least one of the program systems may include a program step in an accessibly coupled memory to its computer slew rate determining the slew rate control using the slew rate based upon the track. Each of these computers preferably includes at least one data processor and at least one instruction processor, where each data processor is directed by at least one of the instruction processors. The servo program system preferably includes the program step following the track, and the embedded program system preferably includes the program step writing the track using the write current waveform.

The invention's hard disk drive includes the embedded circuit electrically coupling to a head stack assembly, which further includes the channel interface electrically coupling to a preamplifier included in the head stack assembly and driving a write signal presented to the write head to write the track on the rotating disk surface, where the write signal is based upon the write current waveform.

The slider may include a read head employing a spin valve and/or a tunneling valve. The slider may include an amplifier electrically coupling to the preamplifier to present the write signal to the write head. The slider may include a vertical micro-actuator to alter a vertical position of the slider above the rotating disk surface. The head stack assembly may include a micro-actuator assembly coupled to the slider to alter a lateral position of the slider and/or a vertical position of the slider above the rotating disk surface. These micro-actuators may employ any combination of a thermal mechanical effect, a piezoelectric effect, and an electrostatic effect.

The invention includes manufacturing the embedded circuit by providing the means for slew rate determining coupling to the means for controlling and electrically coupling the means for controlling to the channel interface to at least partly create the embedded circuit. The embedded circuit is a product of this process.

The invention includes manufacturing the hard disk drive by electrically coupling the embedded circuit to the head stack assembly to create the channel interface electrically coupled to the preamplifier, and initializing the slew rate based upon the track in the embedded circuit using the channel interface electrically coupled to the preamplifier to create the hard disk drive, for at least two of the tracks on the rotating disk surface. The hard disk drive is a product of this process. The write current table may be stored on one of the rotating disk surfaces and/or in a non-volatile memory included in the embedded circuit. The non-volatile memory may be included in at least one of the servo memory servo accessibly coupled to a servo computer, the embedded memory embedded accessibly coupled to the embedded computer, the finite state machine, the neural network, and/or the inferential engine.

Initializing the slew rate may include initializing a write current table by initializing at least two write waveform entries. A write waveform entry may preferably include at least one track group including one of the tracks. The track group may be explicitly included as a field in a record or data structure, or may be implicit through the relative position of the waveform entry in the table. The write waveform entries for a specific track group may use a pointer to a linked list of write waveform entries. The write current table may preferably be implemented either as part of a larger table and/or as an array of the pointers to these linked lists.

### BRIEF DESCRIPTION OF THE DRAWINGS

FIGS. 1A and 1B show aspects of the invention's control of the write current waveform using a slew rate based upon at least the track being accessed in a hard disk drive as shown in FIGS. 2 to 4 and 6;

FIG. 5A shows some further details of the hard disk drive;

FIG. 5B shows an example of a head gimbal assembly employing a piezoelectric effect included in the invention's hard disk drive;

FIGS. 6 and 7 show some details of certain embodiments of the invention's hard disk drive;

FIGS. 8A and 8B show some details of a head gimbal assembly employing an electrostatic effect included in the invention's hard disk drive;

FIGS. 9A and 9B show examples of the read heads which may be used in the invention's read-write head;

FIGS. 9C and 9D show examples of the magnetic polarization of the bit domains of a track included on a disk surface in accord with the invention; and

FIGS. 10A to 11C show examples of some details of the embedded circuit of the previous Figures.

### DETAILED DESCRIPTION

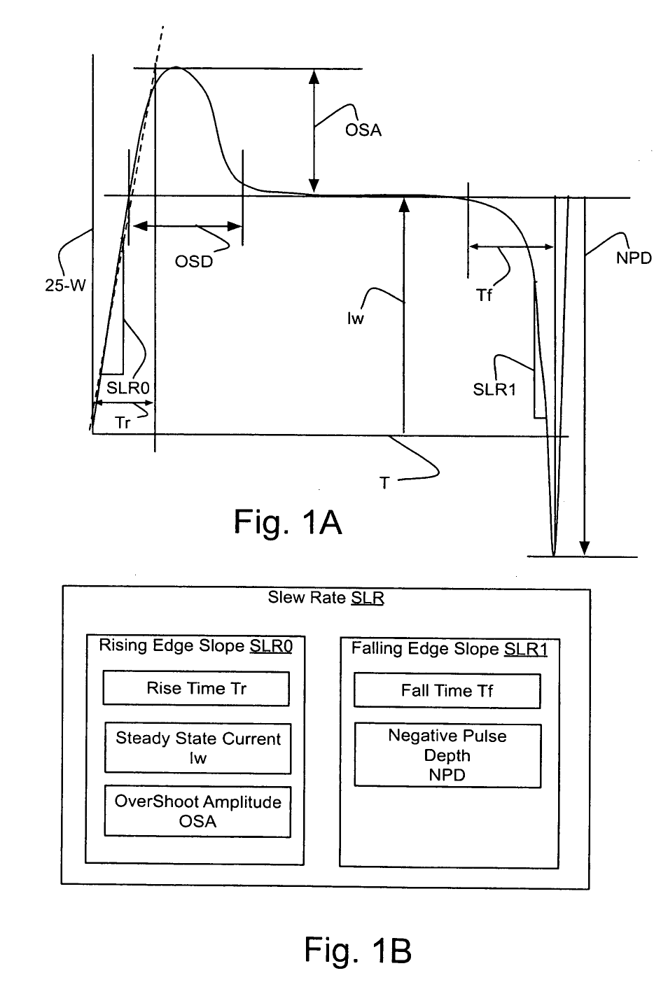

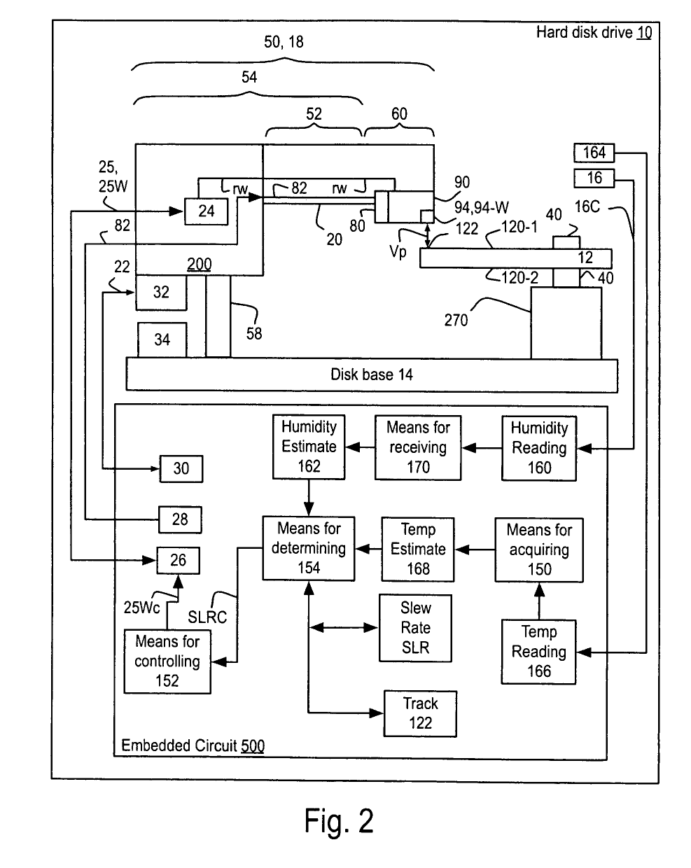

This invention relates to writing data in hard disk drives, in particular, to apparatus and methods for controlling the shape of the write current stimulating a write head to alter the disk surface forming a track, in particular, by controlling the shape specifically for the track being written. The invention includes a method of operating a write head 94-W in a slider 90 to write data in a track 122 on a rotating disk surface 120-1 in a hard disk drive 10 by slew rate determining 154 a slew rate control SLRC using a slew rate SLR based upon the track and controlling 152 the write current waveform 25Wc generated by a channel interface 26 based upon the slew rate control, where the slew rate includes at least a rising edge slope SLR0, as shown in FIGS. 1A to 4. As the track changes, its radius changes and the distance traveled by the slider over the rotating disk surface changes. Being able to control the slew rate differently for different tracks means that the hard disk drive 10 can compensate for these changes in velocity. The slew rate may further include a falling edge slope SLR1. The write current waveform is a product of this process.

This method operates the write head 94-W by controlling the slew rate SLR of an overshoot pulse in the write current waveform 25W used to stimulate the write head to alter the magnetic field of a bit zone in a track 122 on a rotating disk surface 120-1 in the hard disk drive 10. This control of the slew rate optimizes write performance in terms of overwrite and non-linear transition shift by tending to match the recording bubble expansion velocity with the disk velocity based upon the track being written.

Controlling 152 the slew rate of the write current 25-W uses a slew rate control SLRC determined 154 based upon the track number 122 and a slew rate SLR associated with the track number. The slew rate may further be preferably based upon the disk surface 120-1 including the track, and/or a temperature estimate 168 and/or a humidity estimate 162 as shown in FIGS. 2 to 4 and 6. The invention addresses and overcomes degradation in writing performance for both cases, V_bubble<V_disk and V_bubble>V_disk.

FIG. 1A shows some of the details of the write current waveform 25W over time T. The slew rate SLR may include the rising edge slope SLR of the write current 25-W waveform as shown in FIG. 1B. The rising edge slope may include a rise time Tr and an OverShoot Amplitude OSA plus the steady state current Iw. The slew rate SLR may further include the falling edge slope SLR1 of the write current 25-W waveform. The falling edge slope may include a fall time Tf and a negative pulse depth NPD. As used herein, the slew rate approximates the slope of write current on rise/fall edges with respect to time which is in units of electrical current over time, preferably milliamps (mA) per nanoseconds (ns), or mA/ns.

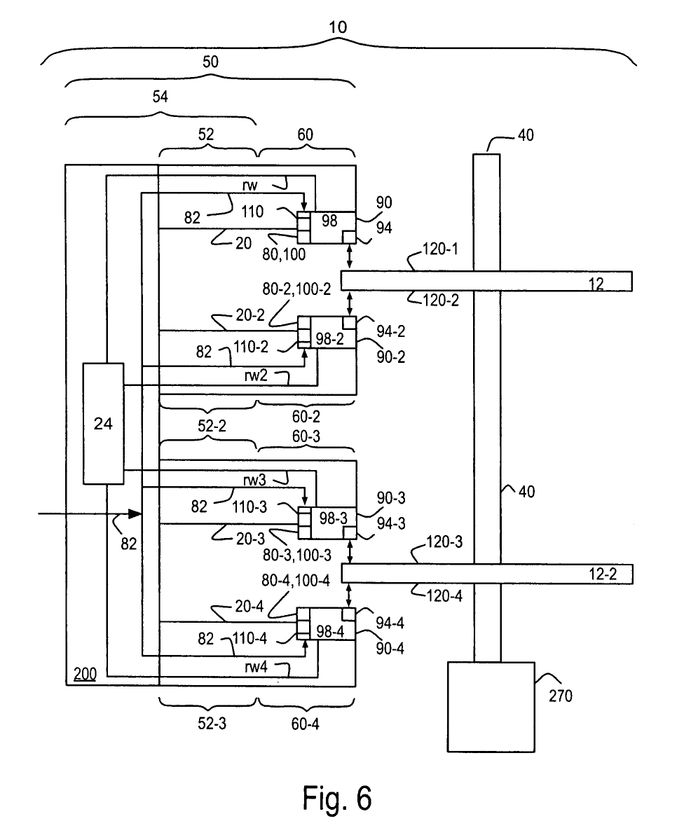

Slew rate determining 154 the slew rate control SLRC may further be based upon any combination of the following: the rotating disk surface 120-1 containing the track 122 as further discussed regarding FIG. 6 and/or a temperature estimate 168 and/or a humidity estimate 162.

The invention includes an embedded circuit 500 for use in the invention's hard disk drive 10 and supporting the invention's method of operation. It preferably includes a means for slew rate determining 154 the slew rate control SLRC using the slew rate SLR based upon the track 122 to be written and a means for controlling 152 the write current waveform 25W generated by the channel interface 26 based upon the slew rate control SLRC.

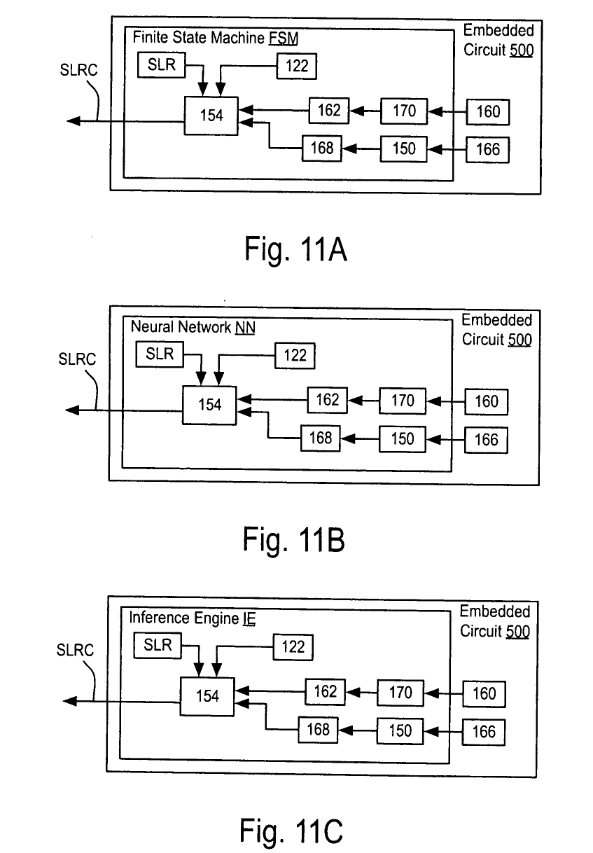

The means for slew rate determining 154 the slew rate control SLRC may be at least partly implemented by at least one of the following: a servo computer 610 as shown in FIG. 4, an embedded computer 502 as shown in FIG. 3, a finite state machine FSM as shown in FIG. 11A, a neural network NN as shown in FIG. 11B and an inferential engine IE, where the servo computer is directed by a servo program system 630 and the embedded computer is directed by an embedded program system 530. At least one of the program systems may include a program step in an accessibly coupled memory to its computer slew rate determining the slew rate control using the slew rate based upon the track. Each of these computers preferably includes at least one data processor and at least one instruction processor, where each data processor is directed by at least one of the instruction processors. The servo program system preferably includes the program step following the track, and the embedded program system preferably includes the program step writing the track using the write current waveform.

Returning to FIGS. 2 to 5A, the hard disk drive 10 may preferably include an embedded circuit 500, which in turn includes a means for controlling 152 the write current waveform 25W used to stimulate the read-write head 94 to write to the track 122 on the rotating disk surface 120-1. The means for controlling is presented a slew rate control SLRC which is slew rate determined 154 based upon the slew rate SLR based upon at least the track to be written. This allows for differences in surface velocity between tracks to be taken into account, as well as media anomalies associated with different regions of the disk surface. The slew rate used to control the write current waveform may further be based upon a temperature estimate 168 and/or a humidity estimate 162.

The embedded circuit 500 may include a computer at least partly implementing the invention's method of operation. Two examples of such embedded circuits are shown. The embedded circuit may includes an embedded computer 502 embedded accessibly coupled 512 to an embedded memory 514 and directed by an embedded program system 530 including program steps residing in the embedded memory as shown in FIG. 3. Alternatively, the embedded circuit may include a servo computer 610 servo accessibly coupled 612 to a servo memory 620 and directed by a servo program system 630 including program steps residing in the servo memory as shown in FIG. 4. At least one of these program steps may preferably implement the means for slew rate determining 152 the slew rate control SLRC using the slew rate SLR based upon the track 122 to be written.

The embedded circuit 500 may include a finite state machine FSM implementing the means for slew rate determining 154 the slew rate control SLRC using the slew rate SLR based upon the track 122 as shown in FIG. 11A. Alternatively, the embedded circuit may include a neural network NN implementing the means for slew rate determining as shown in FIG. 11B. Also, the embedded circuit may include an inference engine IE implementing the means for slew rate determining as shown in FIGS. 11C.

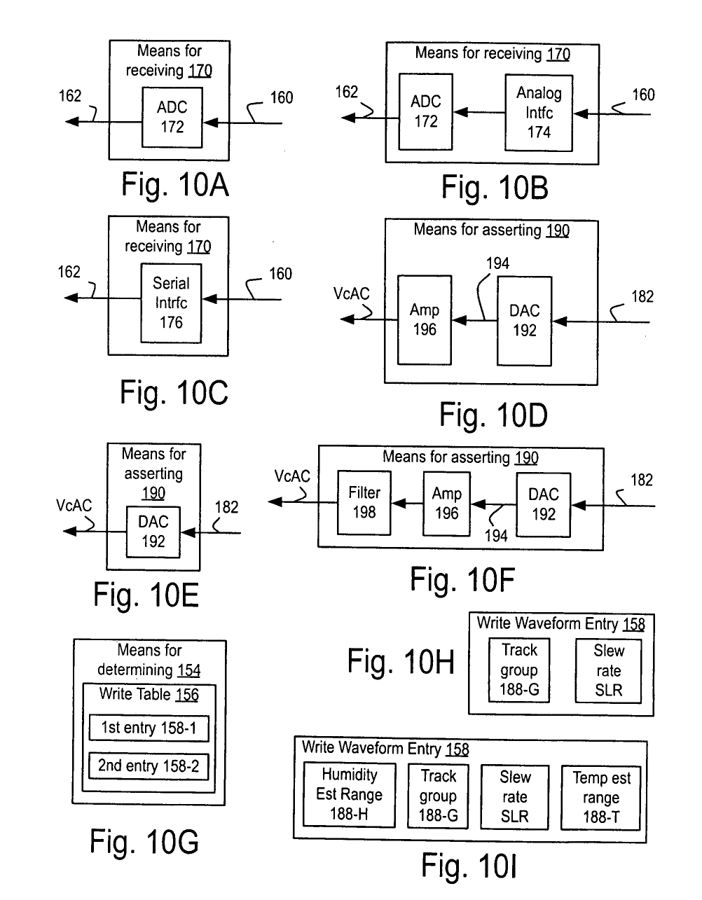

The means for slew rate determining 154 may include a write current table 156, including at least two write waveform entries, for example, a first write waveform entry 158-1 and a second write waveform entry 158-2 as shown in FIG. 10G. A write waveform entry 158 may include a track group 188-G and a slew rate SLR, as shown in FIG. 10H. the write waveform entry may further include a temperature estimate range 188-T and/or a humidity estimate range 188-H, as shown in FIG. 10I. As used herein the collection of track groups cover the tracks on the rotating disk surface 120-1, so that each track 122 belongs to exactly one and only one track group. The tracks belonging to one track group preferably are radial neighbors of each other, so that the read-write head traveling from one of these tracks to another in the same track group, passes over only tracks belonging to the track group.

The invention also recognizes that the air gap between a slider 90 and the rotating disk surface 120-1 accessed by the slider tends to change in response to humidity changes within the hard disk drive 10. Including a humidity sensor 16 in a hard disk drive adds the ability to compensate for humidity change, as shown in FIGS. 2 to 5A. Experiments by the assignee have found that even at moderate temperatures, for example forty five degrees Centigrade (° C.), if the relative humidity is high, say 90%, then enough water is present to reduce the magnetic spacing by more than one nanometer (nm), where the optimal flying height was under ten nm. In further experiments, a contemporary hard disk drive was modified to measure relative humidity and provide an estimate of the vertical position VP of the slider over the rotating disk surface. When the temperature was kept at 53° C. and the humidity changed from 6% to 64%, the vertical position of a slider changed by about 2 nm.

The invention's hard disk drive 10 preferably includes the embedded circuit 500 electrically coupling to a head stack assembly 50, which further includes the channel interface 26 electrically coupling to a preamplifier 24 included in the head stack assembly and driving a write signal 25W presented to the write head 94-W to write the track 122 on the rotating disk surface 120-1, where the write signal is based upon the write current waveform 25Wc.

The slider 90 may include a read head 94-R employing a spin valve and/or a tunneling valve. The slider may include an amplifier 96 electrically coupling to the preamplifier 24 to present the write signal 25W to the write head 94-W. The slider may include a vertical micro-actuator 98 to alter the vertical position Vp of the slider above the rotating disk surface 120-1. The head stack assembly 50 may include a micro-actuator assembly 80 coupled to the slider to alter a lateral position of the slider and/or the vertical position of the slider above the rotating disk surface. These micro-actuators may employ any combination of a thermal mechanical effect, which will be discussed regarding the vertical micro-actuator, a piezoelectric effect, and an electrostatic effect.

Preferably, the hard disk drive 10 includes the humidity sensor 16 communicatively coupled 16C to an embedded circuit 500 providing a humidity reading 160 used to control the vertical position VP of at least one slider 90 accessing a rotating disk surface 120-1. The flying height control 182 may be determined 180 based upon the track 122 that the slider 90 is following on the rotating disk surface 120-1. The tracks of the rotating disk surface may preferably be organized into track groups of consecutive tracks, and the flying height control may preferably be determined based upon the track group the track belongs to. The flying height control may further be determined based upon the humidity estimate 162 and a temperature estimate 168 as shown in FIGS. 3 and 4. The temperature estimate may be used to predict changes in the media coercivity and other changes in the vertical position VP. By way of example, when the temperature estimate decreases at the same humidity estimate the flying height control may preferably be altered to lower the vertical position. The temperature estimate may be acquired 150 as a temperature reading 166 from a temperature sensor 164, as shown in FIGS. 2 to 4.

The hard disk drive 10 may further preferably operate as follows. The humidity reading 160 is received 170 from the humidity sensor to create a humidity estimate 162. A flying height control 182 is determined 180 based upon the humidity estimate and/or the temperature estimate 168. The flying height control is asserted 190 to a vertical micro-actuator 98 coupled to the slider to alter the vertical position of the slider over the rotating disk surface.

The means for slew rate determining 154 may preferably respond to the temperature estimate 168 and/or to the humidity estimate 162 alter the slew rate control SLRC. When the slider 90 includes a vertical micro-actuator 98 which is being stimulated to alter the vertical position VP of the slider off the rotating disk surface 120-1, or when the micro-actuator assembly 80 includes a vertical micro-actuation capability which is similarly stimulated, the slew rate control will tend to be less sensitive to the temperature estimate and/or the humidity estimate, and the slew rate SLR may preferably be determined 154 using a write waveform entry 158 as shown in FIG. 10H. When vertical micro-actuation is turned off or not available, the slew rate may preferably be determined using at least one write waveform entry as shown in FIG. 10I, where a humidity estimate range 188-H and a temperature estimate range 188-T, as well as a track group 188-G is provided so that when the track belongs to the track group and the temperature estimate belongs to temperature estimate range and the humidity estimate belongs to the humidity estimate range, then the slew rate is used to determine the slew rate control. As used herein the temperature estimate range may include a indication of a numeric range for the temperature estimate, or alternatively, represent a combination of numeric comparisons and logical operations, for instance if the temperature estimate is below 20° Centigrade may constitute the temperature estimate range. Similarly for the humidity estimate range. The temperature estimate may or may not numerical represent temperature in a standard temperature scale such as Fahrenheit or Centigrade. The humidity estimate may or may not represent humidity in terms of percentages of relative humidity.

The embedded circuit 500 may further support the invention's operations in the hard disk drive 10 by including the following. Means for receiving 170 the humidity reading 160 from the humidity sensor 16 to create the humidity estimate 162. Means for determining 180 the flying height control 182 based upon the humidity estimate. And means for asserting 190 the flying height control to the vertical micro-actuator 98 coupled to the slider 90 to alter the vertical position VP of the slider over the rotating disk surface 120-1.

At least one of these means may preferably be at least partly implemented by at least one instance of at least one of the following. An embedded computer 502 embedded accessibly coupled 512 to an embedded memory 514 and directed by an embedded program system 530 including at least one program step residing in the embedded memory and implementing these means, as shown in FIG. 3. A servo computer 610 servo accessibly coupled 612 to a servo memory 620 and directed by a servo program system 630 including at least one program step residing in the servo memory and implementing at least one of these means, as shown in FIG. 4.

The means for receiving 170 may further include an analog to digital converter 172, an analog interface 174 to the analog to digital converter, and/or a serial interface 176 to the humidity sensor 16, each receiving the humidity reading 160 to create the humidity estimate 162 as shown in FIGS. 10A to 10C.

The means for asserting 190 may further include a digital to analog converter 192 receiving the flying height control 182 to create a DAC output 194 used to at least partly create the vertical control signal VcAC, an amplifier 196 receiving the DAC output to create an amplified output used to further create the vertical control signal, and/or a filter 198 of at least one the DAC output and the amplified output to further create the vertical control signal as shown in FIGS. 10D to 10F.

In certain embodiments, the embedded computer 502 directed by the embedded program system 530 may at least partly implement and/or may preferably include each of the following program steps as shown in FIG. 3. Receiving 170 the humidity reading 160 from the humidity sensor 16 to create the humidity estimate 162. Determining 180 the flying height control 182 based upon the humidity estimate. And asserting 190 the flying height control to the vertical micro-actuator 98 coupled to the slider 90 to alter the vertical position VP of the slider over the rotating disk surface 120-1.

Alternatively, the servo computer 610 directed by the servo program system 630 may implement each of the members of the means group as shown in FIG. 4. The servo program system may preferably include each of the program steps discussed for the embedded program system above.

Alternatively, the finite state machine FSM as shown in FIG. 11A may be implemented using an Application Specific Integrated Circuit (ASIC) and/or a Programmable Logic Device (PLD). As used herein, the ASIC may include a standard cell integrated circuit, a mixed signal integrated circuit and/or a gate array. The PLD may include a Field Programmable Gate Array, a Programmable Logic Array, or a network including one or more instances of these elements.

Alternatively, the neural network NN as shown in FIG. 11B may include a digital logic neural network and/or as an analog neural network.

Alternatively, the inferential engine IE as shown in FIG. 11C may include a fuzzy logic controller and/or an inference processor receiving the humidity reading to determine the flying height control through inference based upon the humidity reading.

Returning to FIGS. 2 to 4, the embedded circuit 500 may preferably be implemented with a printed circuit technology and/or an integrated circuit technology. The lateral control signal 82 may preferably be generated by a micro-actuator driver 28. The lateral control signal preferably includes the first lateral control signal and the second lateral control signal, as well as the AC lateral control signal. The lateral control signal may further include one or more second micro-actuator lateral control signals.

The voice coil driver 30 preferably stimulates the voice coil motor 18 through the voice coil 32 to provide coarse position of the slider 90, in particular, the read head 94-R or the write head near the track 122 on the disk surface 120-1. The read head is positioned for reading and the write head is positioned for writing.

The embedded circuit 500 may further process the read signal 25-R during the read access to the data 122 on the disk surface 120-1. The slider 90 may include an amplifier 96. The slider reports the amplified read signal as the result of a read access of the data on the disk surface. The flexure finger 20 may provide the read trace path for the amplified read signal as part of the read-write signal paths rw. The main flex circuit 200 may receive the amplified read signal from the read trace path to create the read signal as part of a read-write signal 25.

The invention includes manufacturing the embedded circuit 500 by providing the means for slew rate determining 154 coupling to the means for controlling 152 and electrically coupling the means for controlling to the channel interface 26 to at least partly create the embedded circuit. The embedded circuit is a product of this process.

The invention includes manufacturing the hard disk drive 10 by electrically coupling the embedded circuit 500 to the head stack assembly 50 to create the channel interface 26 electrically coupled to the preamplifier 24, and initializing the slew rate SLR based upon the track 122 in the embedded circuit using the channel interface electrically coupled to the preamplifier to create the hard disk drive, for at least two of the tracks on the rotating disk surface 120-1. The hard disk drive is a product of this process. The write current table 156 may be stored on one of the rotating disk surfaces and/or in a non-volatile memory included in the embedded circuit. The non-volatile memory may be included in at least one of the servo memory 620 servo accessibly coupled 612 to the servo computer 610, the embedded memory 514 embedded accessibly coupled 512 to the embedded computer 502, the finite state machine FSM, the neural network NN, and/or the inferential engine IE. As used herein, a non-volatile memory retains its memory state without being provided power, whereas a volatile memory does not tend to retain its memory state without being regularly provided power.

Initializing the slew rate SLR may include initializing the write current table 156 by initializing at least two write waveform entries, as shown in FIG. 10G. A write waveform entry may preferably include an indication of at least one track group, known herein as a track group indication 188-G, where the track group includes one of the tracks. The track group may be explicitly included as a field in a record or data structure, or may be implicit through the relative position of the waveform entry in the table. The write waveform entries for a specific track group may use a pointer to a linked list of write waveform entries. The write current table may preferably be implemented either as part of a larger table and/or as an array of the pointers to these linked lists.

In greater detail, manufacturing the embedded circuit 500 may preferably include initializing a program system directing a computer. For example the initialization may use the embedded program system 530 to direct the embedded computer 502 to create the write current table 156, and to further create a write waveform entry 158, possibly for each track group 188-G on the disk surface 120-1. A track group may have several write waveform entries with differing temperature estimate range 188-T and/or differing humidity estimate range 188-H values, giving separate slew rates. Alternatively, several track groups may share the same write waveform entry. The embedded circuit is a product of this manufacturing process.

The initializing of the write current table 156 may include optimizing first for the steady state current Iw, followed by further optimization for the rising edge slope SLR0, with its added parameters of rise time Tr and overshoot amplitude OSA as shown in FIGS. 1A and 1B. The overshoot duration OSD may then be optimized. The falling edge slope SLR1 may then be optimized to provide the fall time Tf and the negative pulse depth NPD.

Optimization may involve the use of Bit Error Rate and/or overwrite performance estimates to evaluate alternative settings for these parameters. Overwrite performance may be estimate by using the writing and subsequent reading of the track 122 using a low frequency pattern alternating with using a high frequency pattern. Preferably today, the low frequency pattern has a central frequency of 50 MHz and the high frequency pattern has a central frequency of 350 MHz. The ratio of the spectral density of the retained low frequency pattern to the original low frequency pattern is converted to decibels, typically by taking the logarithm base 2 of the ratio and multiplying that by 20, which gives the overwrite performance. The requirement is that the overwrite performance should be at least 20 and preferably at least 30 decibels.

The term central frequency is used to denote the center of a very narrow bandwidth signal being used. In practice, the signal is almost never a perfect harmonic, but is a very narrow bandwidth signal.

Manufacturing may further include providing the humidity sensor 16 and/or the temperature sensor 164 and/or coupling the humidity sensor through a communicative coupling 16C to the embedded circuit 500 and/or coupling the temperature sensor to create the hard disk drive 10. The manufacturing may further include coupling the disk base 14 to the disk cover 17 to enclose the humidity sensor and/or the temperature sensor.

Returning to the embedded circuit 500 may preferably provide a communicative coupling 16C for the humidity sensor 16 to the embedded circuit to provide the humidity reading 160. Manufacturing may further include programming the embedded program system 530, the servo program system 630, the finite state machine FSM, the neural network NN and/or the inferential engine IE to at least partly implement the operations of the invention. Programming the embedded program system may preferably include programming a non-volatile memory component of the embedded memory 514. Similarly, programming the servo program system may preferably include programming a non-volatile memory component of the servo memory 620.

The humidity sensor 16 may preferably measure at least one of the properties of a resistance, a capacitive and/or a thermal conductance. These measures are taken for materials possessing the property as a function of water pressure. The disk base 14 and the disk cover 17 may preferably enclose the humidity sensor.

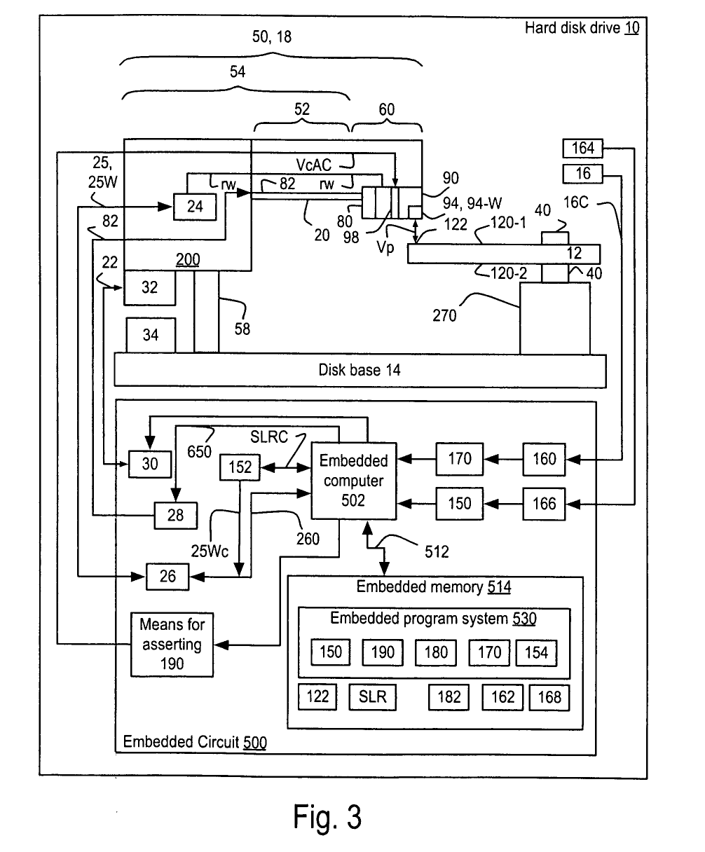

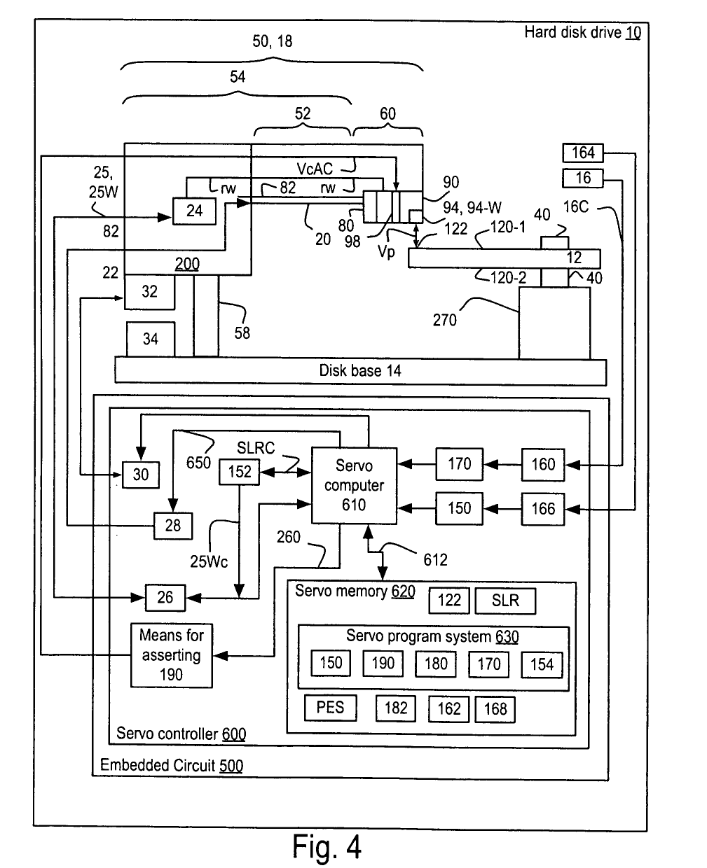

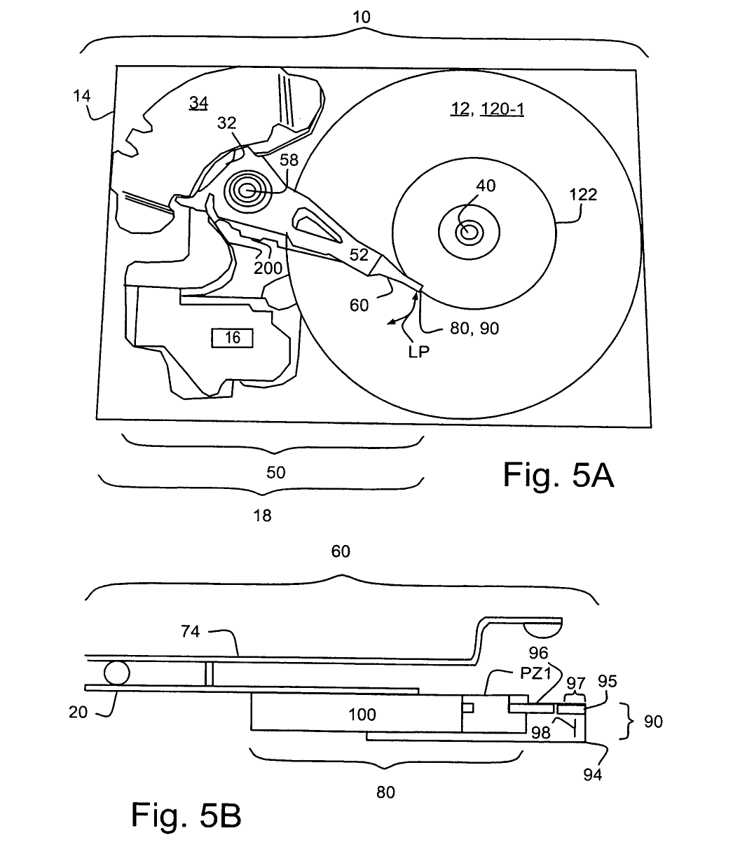

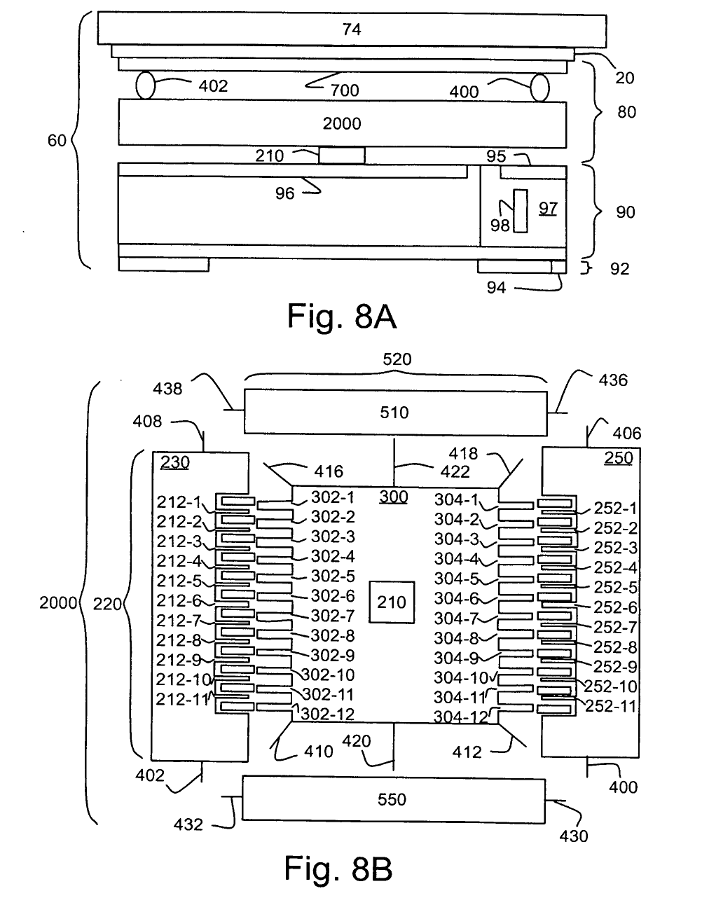

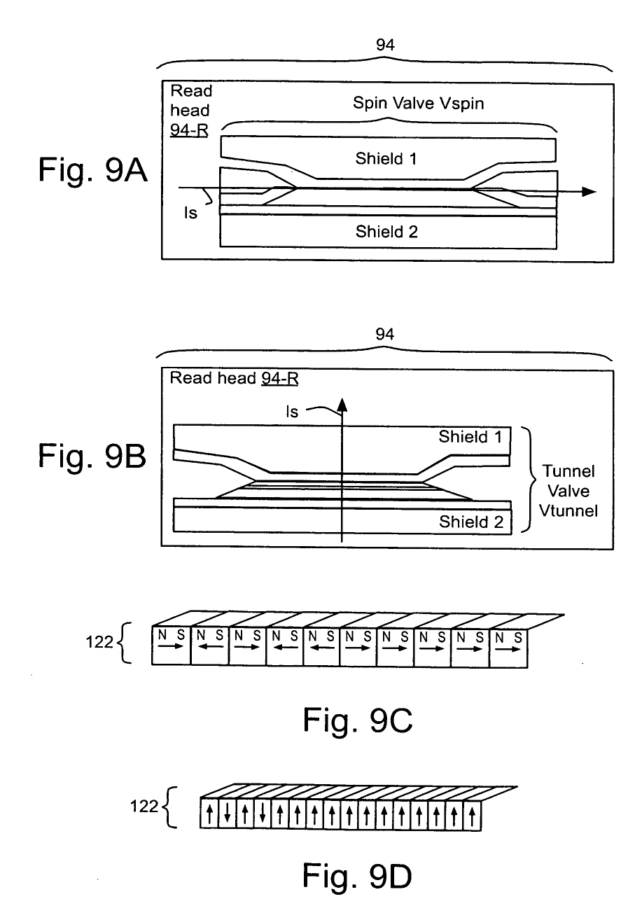

Returning to the hard disk drive 10, the vertical micro-actuator may include a vertical micro-actuator element 98 embedded in the slider 90 and/or a micro-actuator assembly 80 coupled to the slider. The micro-actuator assembly may employ a piezoelectric effect as shown in FIG. 5B and/or an electrostatic effect as shown in FIGS. 8A and 8B. The slider may include a spin valve as shown in FIG. 9A or a tunnel valve as shown in FIG. 9B. The track 122 of FIGS. 2 to 5A may include represent bits by magnetic polarizations parallel to the disk surface 120-1 as shown in FIG. 9C or perpendicular to the disk surface as shown in FIG. 9D.

In further detail, the head gimbal assembly 60 may preferably include a micro-actuator assembly 80, which may employ at least one of the following: a piezoelectric effect and/or an electrostatic effect and/or a thermal-mechanical effect as discussed regarding the vertical micro-actuator 98 in the slider 90.

The slider 90, and its read-write head 94 may include a read head 94-R using a spin valve to read the data on the disk surface 120-1, or use a tunneling valve to read the data. The slider may include a vertical micro-actuator 98 for altering the vertical position Vp of the read-write head above the disk surface. The slider may further include the read head providing a read differential signal pair to an amplifier 96 to generate an amplified read signal reported by the slider as a result of the read access of the data on the disk surface. The amplifier may be opposite the air bearing surface 92, and may be separate from the deformation region 97, and may further be separate from the vertical micro-actuator 98.

The slider 90 may include a vertical micro-actuator 98, coupled to a deformation region 97 including a read-write head 94 and stimulated by a vertical control signal VcAC providing a potential difference with a first slider power terminal, possibly by heating the deformation region to alter the vertical position Vp of the read-write head over the disk surface 120-1 in a hard disk drive 10 as shown in FIG. 8A. the slider may further include a heat sink 95 which may preferably minimize the probability of the slider overheating from the operation of the vertical micro-actuator.

The slider 90 is used to access the data 122 on the disk surface 120-1 in a hard disk drive 10. The data is typically organized in units known as a track 122, which are usually arranged in concentric circles on the disk surface centered about a spindle shaft 40 and alternatively may be organized as joined spiral tracks. Operating the slider to read access the data on the disk surface includes the read head 94-R driving the read differential signal pair to read access the data on the disk surface. The read-write head 94 is formed perpendicular to the air bearing surface 92.

The read head 94-R may use a spin valve to drive the read differential signal pair as shown in FIG. 9A. As used herein, the spin valve employs a magneto-resistive effect to modulate a sensing voltage, or alternatively, a sensing current Is, which is conducted from one lead, through the magneto-resistive element to the other lead. The magneto-resistive element is located between the first shield Shield1 and the second shield Shield2. Spin valves have been in use the since the mid 1990's.

The read head 94-R may use a tunnel valve to drive the read differential signal pair as shown in FIG. 9B. As used herein, a tunnel valve uses a tunneling effect to modulate the sensing current Is perpendicular to the first shield Shield1 and the second shield Shield2. Both longitudinally recorded signals as shown in FIG. 9C and perpendicularly recorded signals shown in FIG. 9D can be read by either reader type. Perpendicular versus longitudinal recording relates to the technology of the writer/media pair, not just the reader.

The tunnel valve is used as follows. A pinned magnetic layer is separated from a free ferromagnetic layer by an insulator, and is coupled to a pinning antiferromagnetic layer. The magneto-resistance of the tunnel valve is caused by a change in the tunneling probability, which depends upon the relative magnetic orientation of the two ferromagnetic layers. The sensing current Is, is the result of this tunneling probability. The response of the free ferromagnetic layer to the magnetic field of the bit of the track 122 of the disk surface 120-1, results in a change of electrical resistance through the tunnel valve.

The flexure finger 20 for the slider 90 of FIGS. 2 to 6, preferably contains a micro-actuator assembly 80 for mechanically coupling to the slider to aid in positioning the slider to access the data 122 on 120-1 disk surface of the disk 12. The micro-actuator assembly may aid in laterally positioning LP the slider to the disk surface as shown in and/or aid in vertically positioning VP the slider. The flexure finger 20 may further provide the vertical control signal VcAC and preferably the first lateral control signal as the first slider power terminal to the vertical micro-actuator.

The flexure finger 20 preferably includes the lateral control signal 82 and trace paths between the slider for the write differential signal pair. The lateral control signal preferably includes the first lateral control signal and the second lateral control signal, as well as the AC lateral control signal. When the slider does not contain an amplifier 96, the flexure finger further preferably provides trace paths for the read differential signal pair.

The micro-actuator assembly 80 may employ a piezoelectric effect and/or an electrostatic effect to aid in positioning the slider 90. First, examples of micro-actuator assemblies employing the piezoelectric effect will be discussed followed by electrostatic effect examples. In several embodiments of the invention the micro-actuator assembly may preferably couple with the head gimbal assembly 60 through the flexure finger 20, as shown in FIG. 5B. The micro-actuator assembly may further couple through the flexure finger to a load beam 74 to the head gimbal assembly and consequently to the head stack assembly 50.

Examples of micro-actuator assemblies employing the piezoelectric effect are shown in FIG. 5B, which shows a side view of a head gimbal assembly with a micro-actuator assembly 80 including at least one piezoelectric element PZ1 for aiding in laterally positioning LP of the slider 90. In certain embodiments, the micro-actuator assembly may consist of one piezoelectric element. The micro-actuator assembly may include the first piezoelectric element and a second piezoelectric element, both of which may preferably aid in laterally positioning the slider. In certain embodiments, the micro-actuator assembly may be coupled with the slider with a third piezoelectric element to aid in the vertically positioning the slider above the disk surface 120-1.

Examples of the invention using micro-actuator assemblies employing the electrostatic effect are shown in FIGS. 8A and 8B derived from the Figures of U.S. patent application Ser. No. 10/986,345, which is incorporated herein by reference. FIG. 8A shows a schematic side view of the micro-actuator assembly 80 coupling to the flexure finger 20 via a micro-actuator mounting plate 700. FIG. 8B shows the micro-actuator assembly using an electrostatic micro-actuator assembly 2000 including a first electrostatic micro-actuator 220 to aid the laterally positioning LP of the slider 90. The electrostatic micro-actuator assembly may further include a second electrostatic micro-actuator 520 to aid in the vertically positioning VP of the slider.

The first micro-actuator 220 includes the following. A first pivot spring pair 402 and 408 coupling to a first stator 230. A second pivot spring pair 400 and 406 coupling to a second stator 250. A first flexure spring pair 410 and 416, and a second flexure spring pair 412 and 418, coupling to a central movable section 300. A pitch spring pair 420-422 coupling to the central movable section 300. The central movable section 300 includes signal pair paths coupling to the write differential signal pair and either the read differential signal pair or the amplified read signal of the read-write head 94 of the slider 90.

The bonding block 210 may electrically couple the read-write head 90 to the amplified read signal and write differential signal pair, and mechanically couples the central movable section 300 to the slider 90 with read-write head 94 embedded on or near the air bearing surface 92 included in the slider.

The first micro-actuator 220 aids in laterally positioning LP the slider 90, which can be finely controlled to position the read-write head 94 over a small number of tracks 122 on the disk surface 120-1. This lateral motion is a first mechanical degree of freedom, which results from the first stator 230 and the second stator 250 electrostatically interacting with the central movable section 300. The first micro-actuator 220 may act as a lateral comb drive or a transverse comb drive, as is discussed in detail in the incorporated United States Patent Application.

The electrostatic micro-actuator assembly 2000 may further include a second micro-actuator 520 including a third stator 510 and a fourth stator 550. Both the third and the fourth stator electostatically interact with the central movable section 300. These interactions urge the slider 90 to move in a second mechanical degree of freedom, aiding in the vertically positioning VP to provide flying height control. The second micro-actuator may act as a vertical comb drive or a torsional drive, as is discussed in detail in the incorporated United States Patent Application. The second micro-actuator may also provide motion sensing, which may indicate collision with the disk surface 120-1 being accessed.

The central movable section 300 not only positions the read-write head 10, but may act as the conduit for the write differential signal pair and in certain embodiments, the first slider power signal and the second slider power signal, as well as the read differential signal pair or the amplified read signal. The electrical stimulus of the first micro-actuator 220 is provided through some of its springs.

The central movable section 300 may preferably to be at ground potential, and so does not need wires. The read differential signal pair, the amplified read signal, the write differential signal pair and/or the slider power signals and traces may preferably be routed with flexible traces all the way to the load beam 74 as shown in FIG. 8A.

The flexure finger 20 may further provide a read trace path rtp for the amplified read signal. The slider 90 may further include a first slider power terminal and a second slider power terminal, both electrically coupled to the amplifier 96 to collectively provide power to generate the amplified read signal. The flexure finger may further include a first power path electrically coupled to the first slider power terminal and/or a second power path electrically coupled to the second slider power terminal, which are collectively used to provide electrical power to generate the amplified read signal.

The hard disk drive 10 preferably includes the disk base 14 coupled to the disk cover 17 to enclose the humidity sensor 16 and/or the temperature sensor 164.

In further detail, the head gimbal assembly 60 may further provide the vertical control signal VcAC to the heating element of the vertical micro-actuator 98, as shown in FIGS. 2 to 4 and 6. Operating the head gimbal assembly may further preferably include driving the vertical control signal. The flexure finger 20 may be coupled to the load beam 74 as shown in FIG. 5B.

The head gimbal assembly 60 includes a base plate 72 coupled through a hinge 70 to a load beam 74. Often the flexure finger 20 is coupled to the load beam and the micro-actuator assembly 80 and slider 90 are coupled through the flexure finger to the head gimbal assembly.

The head stack assembly 50 includes at least one head gimbal assembly 60 coupled to a head stack 54, as shown in FIGS. 5A and 6.

The head stack assembly 50 may include more than one head gimbal assembly 60 coupled to the head stack 54. By way of example, FIG. 6 shows the head stack assembly coupled with a second head gimbal assembly 60-2, a third head gimbal assembly 60-3 and a fourth head gimbal assembly 60-4. Further, the head stack, as also shown in FIGS. 1 to 4 and 5A, includes the actuator arm 52 coupling to the head gimbal assembly. In FIG. 6, the head stack further includes a second actuator arm 52-2 and a third actuator arm 52-3, with the second actuator arm coupled to the second head gimbal assembly 60-2 and a third head gimbal assembly 60-3, and the third actuator arm coupled to the fourth head gimbal assembly 60-4. The second head gimbal assembly includes the second slider 90-2, which contains the second read-write head 94-2. The third head gimbal assembly includes the third slider 90-3, which contains the third read-write head 94-3. And the fourth head gimbal assembly includes a fourth slider 90-4, which contains the fourth read-write head 94-4.

The hard disk drive 10 may further use a second disk surface 120-2 of the disk 12. The hard disk drive may include more than one disk, for example, a second disk 12-2 and use a third disk surface 120-3 and a fourth disk surface 120-4.

In certain embodiments, the head stack assembly 50 preferably operates as follows: for each of the sliders 90 included in each of the head gimbal assemblies 60 of the head stack, when the temperature of the shape memory alloy film in the vertical micro-actuator 98 of the slider is below a first temperature, the film configures in a first solid phase to the deformation region 97 to create the vertical position VP of that read-write head above its disk surface. Whenever the temperature of the film of the shape memory alloy is above the first temperature, the film configures in a second solid phase to the deformation region increasing the vertical position of the read-write head above the disk surface.

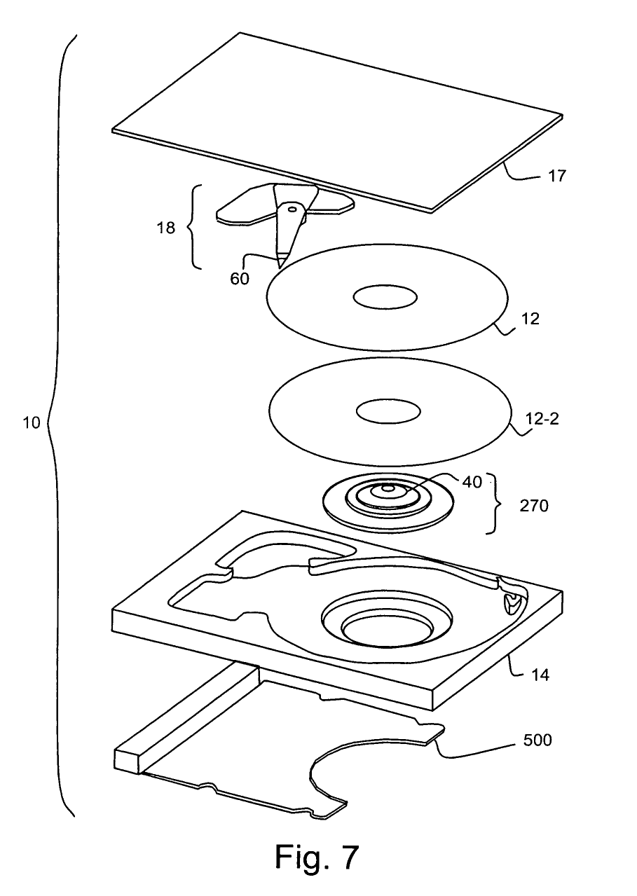

In further detail, the hard disk drive 10, shown in FIGS. 2 to 5A, 6, and 7, includes the head stack assembly 50 pivotably mounted through the actuator pivot 58 on a disk base 14 and arranged for the slider 90 of the head gimbal assembly 60 to be laterally positioned LP near the data 122 for the read-write head 94 to access the data on the disk surface 120-1. The disk 12 is rotatably coupled to the spindle motor 270 by the spindle shaft 40. The head stack assembly is electrically coupled to the embedded circuit 500.

In further detail, manufacturing the hard disk drive 10 may include pivotably mounting the head stack assembly 50 by an actuator pivot 58 to the disk base 14 and arranging the head stack assembly, voice coil 32 and fixed magnet(s) 34, the disk 12, and the spindle motor 270 for the slider 90 of the head gimbal assembly 60 to access the data 122 on the disk surface 120-1 of the disk 12 rotatably coupled to the spindle motor, to at least partly create the hard disk drive. The invention includes this manufacturing process and the hard disk drive as a product of that process.

The voice coil motor 18 is often considered to include the head stack assembly 50 coupling with the voice coil 32 to interact with the fixed magnet(s) 34, which rotating about the actuator pivot 58 above the disk base 14.

Manufacturing the hard disk drive 10 may further include electrically coupling the head stack assembly 50 to the embedded circuit 500 to provide the read signal 25-R as the result of the read access of the data 122 on the disk surface 120-1. It may further include coupling the servo controller 600 and/or the embedded circuit 500 to the voice coil motor 18 and providing the micro-actuator stimulus signal 650 to drive the micro-actuator assembly 80. And electrically coupling the vertical control driver of the embedded circuit to the vertical control signal VcAC of the slider 90 through the head stack assembly 50, in particular through the flexure finger 20.

The read-write head 94 interfaces through a preamplifier 24 on a main flex circuit 200 using a read-write signal bundle rw typically provided by the flexure finger 20, to a channel interface 26 often located within the servo controller 600. The channel interface often provides the Position Error Signal 260 (PES) within the servo controller. It may be preferred that the micro-actuator stimulus signal 650 be shared when the hard disk drive includes more than one micro-actuator assembly. It may be further preferred that the lateral control signal 82 be shared. Typically, each read-write head interfaces with the preamplifier using separate read and write signals, typically provided by a separate flexure finger. For example, the second read-write head 94-2 interfaces with the preamplifier via a second flexure finger 20-2, the third read-write head 94-3 via the a third flexure finger 20-3, and the fourth read-write head 94-4 via a fourth flexure finger 20-4.

During normal disk access operations, the hard disk drive 10 operates as follows when accessing the data 122 on the disk surface 120-1. The spindle motor 270 is directed by the embedded circuit 500, often the servo-controller 600, to rotate the disk 12, rotating the disk surface for access by the read-write head 94. The embedded circuit, in particular, the servo controller drives the voice coil driver 30 to create the voice coil control signal 22, which stimulates the voice coil 32 with an alternating current electrical signal, inducing a time-varying electromagnetic field, which interacts with the fixed magnet 34 to move the voice coil parallel the disk base 14 through the actuator pivot 58, which alters the lateral position LP of the read-write head of the slider 90 in the head gimbal assembly 60 coupled to the actuator arm 52, which is rigidly coupled to the head stack 54 pivoting about the actuator pivot. Typically, the hard disk drive first enters track seek mode, to coarsely position the read-write head near the data, which as stated above, is typically organized as a track. Once the read-write head is close to the track, track following mode is entered. Often this entails additional positioning control provided by the micro-actuator assembly 80 stimulated by the lateral control signal 82, which is driven by the micro-actuator driver 28. In certain embodiments of the hard disk drive supporting triple stage actuation, the second micro-actuator 80A may be further stimulated by one or more second micro-actuator lateral control signals 82A. Reading the track may also include generating a Position Error Signal 260, which is used by the servo controller as positioning feedback during track following mode.

The preceding embodiments provide examples of the invention and are not meant to constrain the scope of the following claims.

What is claimed is:

1. A method of operating a write head in a slider to write data in a track on a rotating disk surface in a hard disk drive, comprising the step:
slew rate determining a slew rate control using a slew rate based upon said track; and
controlling the write current waveform generated by a channel interface based upon said slew rate control;
wherein said slew rate includes a rising edge slope.

2. The method of claim 1, wherein the step slew rate determining said slew rate control further comprises at least one member of the group consisting of the steps:
slew rate determining said slew rate control using said slew rate based upon said track and based upon a rotating disk surface containing said track;
slew rate determining said slew rate control using said slew rate based upon said track and based upon a temperature estimate;
slew rate determining said slew rate control using said slew rate based upon said track and based upon said temperature estimate and a humidity estimate; and
slew rate determining said slew rate control using said slew rate based upon said track and based upon a rotating disk surface containing said track and based upon said temperature estimate and said humidity estimate.

3. The method of claim 1, wherein said slew rate further includes a falling edge slope.

4. The write current waveform as a product of the process of claim 1.

5. An embedded circuit for use in said hard disk drive and supporting the method of claim 1, comprising:
means for slew rate determining said slew rate control using said slew rate based upon said track; and
means for controlling said write current waveform generated by a channel interface based upon said slew rate control.

6. The embedded circuit of claim 5,
wherein said means for slew rate determining is at least partially implemented by at least one member of the group consisting of:
a servo computer servo accessibly coupled to a servo memory and directed by a servo program system including at least one program step residing in said servo memory;
an embedded computer embedded accessibly coupled to an embedded memory and directed by an embedded program system including at least one of said program systems residing in said embedded memory;
a finite state machine;
a neural network; and
an inferential engine;
wherein each member of the group consisting of said servo computer and said embedded computer, includes: at least one data processor and at least one instruction processor; wherein each of said data processor is directed by at least one of said instruction processors.

7. The embedded circuit of claim 7,
wherein at least one member of the group consisting of said servo program system and said embedded program system, includes the program step:
slew rate determining said slew rate control using said slew rate based upon said track;
wherein said servo program system, further includes the program step:
following said track; and
wherein said embedded program system, includes the program step:
writing said track using said write current waveform.

8. A method of manufacturing said embedded circuit of claim 5, comprising the steps:
providing said means for slew rate determining coupling to said means for controlling to at least partly create said embedded circuit; and
electrically coupling said means for controlling to said channel interface to at least partly create said embedded circuit.

9. The embedded circuit as a product of the process of claim 8.

10. The hard disk drive of claim 5, comprising:
said embedded circuit electrically coupling to a head stack assembly, further comprising:
said channel interface electrically coupling to a preamplifier included in said head stack assembly and driving a write signal presented to said write head to write said track on said rotating disk surface;
wherein said write signal is based upon said write current waveform.

11. The hard disk drive of claim 10, wherein said slider includes a read head employing a member of the group consisting of: a spin valve and a tunneling valve.

12. The hard disk drive of claim 10, wherein said slider includes an amplifier electrically coupling to said preamplifier to present said write signal to said write head.

13. The hard disk drive of claim 10, wherein said slider includes a vertical micro-actuator to alter a vertical position of said slider above said rotating disk surface.

14. The hard disk drive of claim 10, wherein said head stack assembly further includes a micro-actuator assembly coupled to said slider to alter at least one member of the group consisting of: a lateral position of said slider and a vertical position of said slider above said rotating disk surface.

15. A method of manufacturing said hard disk drive of claim 10, comprising at least one member of the group consisting of the steps:
electrically coupling said embedded circuit to said head stack assembly to create said channel interface electrically coupled to said preamplifier;
initializing said slew rate based upon said track in said embedded circuit using said channel interface electrically coupled to said preamplifier to create said hard disk drive, for at least two of said tracks on said rotating disk surface.

16. The hard disk drive as a product of the process of claim 15.

17. The method of claim 15, wherein the step initializing said slew rate further includes the step:
initializing a write current table, including the steps:
initializing a first write waveform entry including said slew rate based upon a first of said tracks; and
initializing a second write waveform entry including said slew rated based upon a second of said tracks.

18. The method of claim 17, wherein said first waveform entry includes a track group for said first of said tracks.

19. The method of claim 17, wherein said write current table is stored in at least one member of the group consisting of:
one of said at least one of said rotating disk surfaces; and
non-volatile memory included in said embedded circuit.

20. The method of claim 19, wherein said non-volatile memory is included in at least one member of the group consisting of:
a servo memory servo accessibly coupled to a servo computer;
an embedded memory embedded accessibly coupled to an embedded computer;
a finite state machine;
a neural network; and
an inferential engine.
